(19) United States
(12) Patent Application Publication
(10) Pub. No.: US 2009/0122904 A1
(43) Pub. Date: May 14, 2009

(54) Apparatuses and method for multi-level communication

(75) Inventors: Young-chan Jang, Yongin-si (KR); Hoe-ju Chung, Yongin-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/230,578

(22) Filed: Sep. 2, 2008

(30) Foreign Application Priority Data
Nov. 13, 2007 (KR) 10-2007-0115489

(51) Int. Cl. H04L 25/49

(52) U.S. Cl. 375/286

(57) ABSTRACT

In one embodiment, the apparatus includes a driver circuit configured such that for each symbol in a set of possible symbols, the driver circuit generates at least one data signal at an associated voltage level. Here, adjacent voltage levels defme an associated voltage interval, and the driver circuit is configured to generate the voltage levels such that a central voltage interval is less than at least one of the voltage intervals adjacent to the central voltage interval.

### FOREIGN PRIORITY INFORMATION

The subject application claims priority under 35 U.S.C. 119 on Korean application no. 10/2007-0115489 filed Nov. 13, 2007; the contents of which are hereby incorporated by reference in their entirety.

### BACKGROUND

In both wired and wireless transmission systems, there are limitations on transmit signal bandwidth. While binary signal levels (i.e., either a logic zero level or a logic one level) are commonly used, the use of multi-level signals is a known technique for increasing the data rate of a digital signaling system. Such multi-level signaling is often referred to as multiple pulse amplitude modulation or multi-PAM. Multi-PAM has uses over long distance wired (e.g., fiber optic) and wireless mediums as well as close proximity communication such as by integrated circuits, etc.

PAM is the transmission of data by varying the amplitudes (voltage levels) of the individual pulses in a regularly timed sequence. For example, an N-PAM signaling system uses N symbols with each symbol representing X bits of data; wherein N=2^{x} for X>=1. On the receive side, one or more reference voltages are used to judge the symbol (or data) represented by an input signal. As will be appreciated, the bigger the voltage margin between a received input signal and the reference voltages, the easier detecting the data or symbol represented by the input signal becomes.

FIG. 1A illustrates conventional 4-PAM signaling. As shown, a pair of differential signals In_p and In_n represent a symbol (i.e., a pair of bits D1D0) based on the voltage levels of the differential signals with respect to a high reference voltage refh and a low reference voltage refl. As shown, if the differential signals In_p and In_n fall between the high and low reference voltages refh and refl and the differential signal In_p has a higher voltage than the differential signal In_n, the symbol 10 is represented; if the differential signals In_p and In_n fall above and below the high and low reference voltages refh and refl, respectively, the symbol 11 is represented; if the differential signals In_p and In_n fall between the high and low reference voltages refh and refl and the differential signal In_n has a higher voltage than the differential signal In_p, the symbol 01 is represented; and if the differential signals In_p and In_n fall below and above the low and high reference voltages refl and refh, the symbol 00 is represented.

FIG. 1B illustrates the well-known transition diagram for a 4-PAM signaling system. The diagram shows all of the possibilities of how the differential signals may transition from one voltage level to another in representing the four symbols 00, 01, 10 and 11 of the 4-PAM signaling system. FIG. 1B also shows the voltage levels of the differential signals ideally associated with each symbol, and this relationship is further shown in the table of FIG. 1C. As shown in FIGS. 1B and 1C, the differential signals may transition to voltage levels V3, V2, V1 or V0 where V3>V2>V1>V0. The first and second bits D0 and D1 of each symbol are: 11 if differential signal In_p has the voltage level V3 and differential signal In_n has the voltage level V0; 10 if differential signal In_p has the voltage level V2 and differential signal In_n has the voltage level V1; 01 if differential signal In_p has the voltage level V1 and differential signal In_n has the voltage level V2; and 00 if differential signal In_p has the voltage level V0 and differential signal In_n has the voltage level V3.

As further shown in FIG. 1B, the voltage interval between adjacent voltage levels V3 and V2 is dV2, the voltage interval between adjacent voltage levels V2 and V1 is dV1, and the voltage interval between adjacent voltage levels V1 and V0 is dV0. The voltage intervals are equal such that dV1=dV2=dV0. The high reference voltage refh is set equal to (V3+V2)/2 and the low reference voltage refl is set equal to (V1+V0)/2.

As discussed above, FIG. 1B represents an ideal system. An actual system has dynamic noise in the reference voltages, refh and refl. As shown in FIG. 1B, each reference voltage signal has ±3α dynamic voltage noise. As a result, the worst case voltage margin ΔV of a 4-PAM signaling system, which is for receiving data “11” (“00”), may be expressed by the following equation:

ΔV=(V3−V0)−(refh+3a−(refl−3a))=3dV−2dV−6a=1dV−6a (1)

The timing margins, in a real system, are also affected. While the timing margin of a 4-PAM signaling system when data transits to “10” or “01” may be Teye1, the timing margin of a 4-PAM signaling system when data transits to “11” or “00” may be Teye2 as shown in FIG. 1B. And, as is known, the data rate is dependent on the worst voltage margin and the worst timing margin.

### SUMMARY

The present invention relates to apparatuses for multi-level communication.

In one embodiment, the apparatus includes a driver circuit configured such that for each symbol in a set of possible symbols, the driver circuit generates at least one data signal at an associated voltage level. Here, adjacent voltage levels defme an associated voltage interval, and the driver circuit is configured to generate the voltage levels such that a central voltage interval is less than at least one of the voltage intervals adjacent to the central voltage interval.

In one embodiment, a difference between the central voltage interval and the other voltage intervals is based on a noise magnitude of at least one reference voltage in a receiver circuit, which determines the symbols represented by the data signal.

Another embodiment of an apparatus for multi-level communication includes a reference voltage generating circuit configured to generate reference voltages for determining symbols represented by at least one data signal. The data signal is at different voltage levels for each symbol in a set of possible symbols, and adjacent voltage levels defme an associated voltage interval. A central voltage interval is less than at least one of the voltage intervals adjacent to the central voltage interval, and the reference voltage generating circuit is configured to generate a reference voltage associated with each voltage interval except the central voltage interval. Each reference voltage is at a median of the associated voltage. The apparatus further includes a determination circuit configured to determine the symbol represented by the data signal based on the generated reference voltages.

In one embodiment, the reference voltage generating circuit is configured to calibrate generation of the reference voltages based on the data signal if a calibration enable signal is received.

Yet another embodiment of an apparatus for multi-level communication, includes a determination circuit configured to determine a symbol represented by at least one data signal based on reference voltages, the data signal being at different voltage levels for each symbol in a set of possible symbols, adjacent voltage levels defining an associated voltage interval, a central voltage interval being less than at least one of the voltage intervals adjacent to the central voltage interval; and the reference voltage generating circuit configured to generate the reference voltages, each reference voltage being associated with one of the voltage intervals except the central voltage interval, and each reference voltage being at a median of the associated voltage interval.

In one embodiment, the determination circuit includes at least one comparison circuit configured to compare the data signal to at least one of the reference voltages, and the determination circuit is configured to determine the symbol represented by the data signal based on output from the comparison circuit.

The present invention also relates to methods for multi-level communication.

In one embodiment, the method includes receiving a symbol from a set of possible symbols for transmission, and generating a data signal at a voltage level from a set of possible voltage levels based on the received symbol. Each voltage level in the set of possible voltage levels for the data signal is associated with one of the symbols in the set of possible symbols. The set of voltage levels is such that adjacent voltage levels define an associated voltage interval and a central voltage interval is less than at least one of the voltage intervals adjacent to the central voltage interval.

Another embodiment of the method includes generating reference voltages for determining symbols represented by at least one data signal. The data signal is at different voltage levels for each symbol in a set of possible symbols, and adjacent voltage levels define an associated voltage interval. A central voltage interval is less than at least one of the voltage intervals adjacent to the central voltage interval. The generating step generates a reference voltage associated with each voltage interval except the central voltage interval, and each reference voltage is at a median of the associated voltage interval. The method further includes determining the symbol represented by the data signal based on the generated reference voltages.

In one embodiment, the method includes calibrating the generation of the reference voltages based on the data signal if a calibration enable signal is received.

Another embodiment of the method includes determining a symbol represented by at least one data signal based on reference voltages. The data signal is at different voltage levels for each symbol in a set of possible symbols, and adjacent voltage levels define an associated voltage interval. A central voltage interval is less than at least one of the voltage intervals adjacent to the central voltage interval. The method further includes generating the reference voltages. Each reference voltage is associated with one of the voltage intervals except the central voltage interval, and each reference voltage is at a median of the associated voltage interval.

In one embodiment, the determining step includes comparing the data signal to at least one of the reference voltages, and determining the symbol represented by the data signal based on the comparison.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1A illustrates conventional 4-PAM signaling.

FIG. 1B illustrates the well-known transition diagram for a 4-PAM signaling system.

FIG. 1C illustrates a table showing the voltage levels of the differential signals ideally associated with each symbol for the 4-PAM signaling of FIGS. 1A and 1B.

FIG. 2 illustrates a transceiver system according to an embodiment of the present invention.

FIG. 3 illustrates an embodiment of the drivers in FIG. 2 according to an embodiment of the present invention.

FIG. 4 illustrates a table showing the voltage levels of the differential signals associated with each symbol for a 4-PAM signaling system according to an embodiment of the present invention.

FIG. 5 illustrates a transition diagram for a 4-PAM signaling system according to an embodiment of the present invention.

FIG. 6 illustrates a first embodiment of a control circuit for applying the first and second control voltages in FIG. 3.

FIG. 7 illustrates another embodiment of a control circuit for applying the first and second control voltages in FIG. 3.

FIG. 8A illustrates a flow chart of the method of calibrating the higher reference voltage generated by the reference voltage generating circuit in FIG. 2.

FIG. 8B illustrates a flow chart of the method of calibrating the lower reference voltage generated by the reference voltage generating circuit in FIG. 2.

FIG. 9 illustrates the conversion table embodied in the data conversion unit of FIG. 2.

FIG. 10A illustrates a detailed circuit diagram of a comparator in FIG. 2 according to an embodiment of the present invention.

FIG. 10B illustrates a detailed circuit diagram of a center comparator in FIG. 2 according to an embodiment of the present invention.

FIG. 10C illustrates a detailed circuit diagram of another center comparator in FIG. 2 according to an embodiment of the present invention.

FIG. 11 illustrates a transceiver system according to another embodiment of the present invention.

FIG. 12 illustrates the transition diagram for 8-PAM signaling according to an embodiment of the present invention.

FIG. 13 illustrates a transceiver system according to an embodiment of the present invention for implementing the 8-PAM signaling of FIG. 12.

FIG. 14 illustrates an embodiment of the drivers in FIG. 13 according to an embodiment of the present invention.

### DETAILED DESCRIPTION OF EXAMPLE EMBODIMENTS

Example embodiments will now be described more fully with reference to the accompanying drawings. However, example embodiments may be embodied in many different forms and should not be construed as being limited to the example embodiments set forth herein. Example embodiments are provided so that this disclosure will be thorough, and will fully convey the scope to those who are skilled in the art. In some example embodiments, well-known processes, well-known device structures, and well-known technologies are not described in detail to avoid the unclear interpretation of the example embodiments. Throughout the specification, like reference numerals in the drawings denote like elements.

It will be understood that when an element or layer is referred to as being “on”, “connected to” or “coupled to” another element or layer, it may be directly on, connected or coupled to the other element or layer, or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the example embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

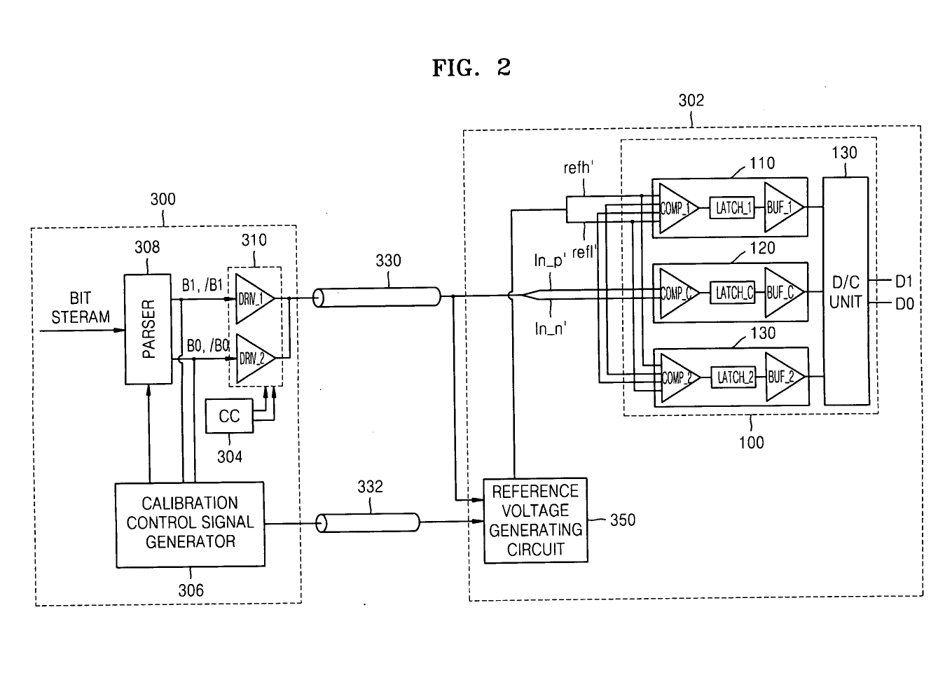

FIG. 2 illustrates a transceiver system according to an embodiment of the present invention. In particular, FIG. 2 illustrates a transceiver system for transmitting and receiving data according to 4-PAM signaling. As will be appreciated from this disclosure, however, the present invention is not limited in application to 4-PAM signaling, but is instead, applicable to an N-PAM signaling where N is three or greater.

As shown in FIG. 2, the transceiver system includes a first circuit device 300 communicatively coupled to a second circuit device 302 via a first transmission medium 330 and a second transmission medium 332. While shown as wired transmission media in FIG. 2, the first and second transmission media 330 and 332 may instead be wireless transmission media. A wired transmission medium may be any wired transmission medium capable of transferring signals representing data such as optical fiber, copper wires or other conductive material, etc. Furthermore, instead of being separate media, the first and second transmission media 330 and 332 may be separate channels on a same transmission media—either wired or wireless.

The first circuit device 300 includes a control circuit 304, a calibration control signal generator 306, a parser 308 and a transmitter 310. The second circuit device 302 includes a receiver 100 and a reference voltage generating circuit 350. It will be understood that the first circuit device 300 and the second circuit device 302 may include other elements and components performing various functions, etc.; however, these other aspects will not be described in detail for the sake of brevity.

As shown, the calibration control signal generator 306 generates calibration control signals, which are sent to the second circuit device 302 to control calibration of the reference voltages generated by the reference voltage generator 350 in the second circuit device 302. This will be described in more detail below with respect to the second circuit device 302. As further shown in FIG. 2, the parser 308 receives a bit stream and parses the bit stream into pairs of bits B1B0. The most significant bit B1 and the inverse /B1 are supplied to a first driver DRV_1 in the transmitter 310. The least significant bit B0 and the inverse /B0 are supplied to a second driver DRV_2 of the transmitter 310. Accordingly, as will be appreciated, the parser 308 parses the bit stream into symbols. The first and second drivers DRV_1 and DRV_2 generate a differential signal pair In_p′ and In_n′ based on the bits B1, /B1, B0, and /B0. In particular, the first and second drivers DRV_1 and DRV_2 generate the differential signal pair In_p′ and In_n′ based on these bits and control voltages received from the control circuit 304.

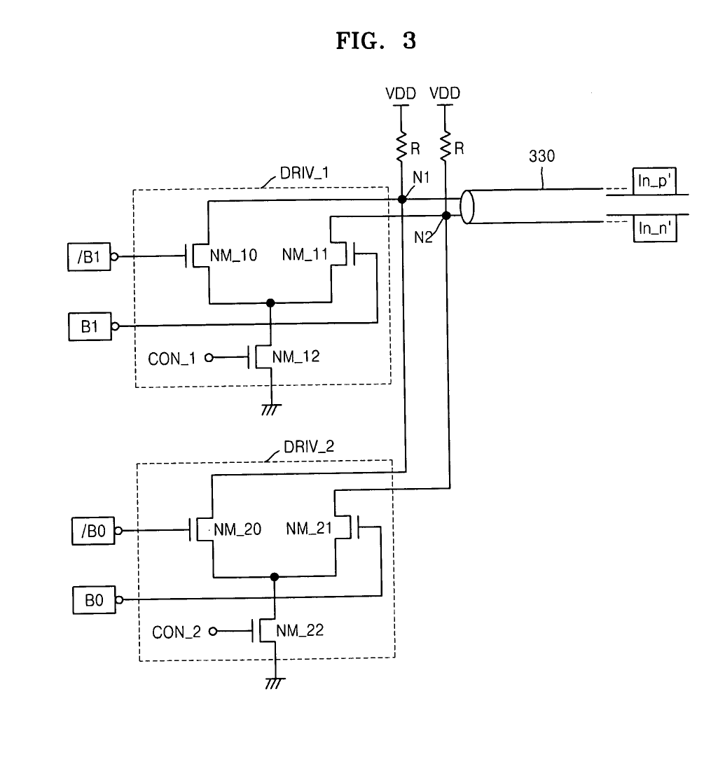

FIG. 3 illustrates an embodiment of the first and second drivers DRV_1 and DRV_2 according to one embodiment of the present invention. As shown, the first driver DRV_1 includes first and second NMOS transistors NM_10 and NM_11 connected in parallel to a third NMOS transistor NM_12. The first NMOS transistor NM_10 is connected in series between a first output node N1 and the third NMOS transistor NM_12, and the second NMOS transistor NM_11 is connected in series between a second output node N2 and the third NMOS transistor NM_12. The first and second NMOS transistors NM_10 and NM_11 receive the inverse of the most significant bit /B1 and the most significant bit B1, respectively, at their gates. The third NMOS transistor NM_12 is connected between ground and the first and second NMOS transistors NM_10 and NM_11. The third NMOS transistor NM_12 receives a first control voltage CON_1 at its gate from the control circuit 304.

The second driver DRV_2 includes fourth and fifth NMOS transistors NM_20 and NM_21 connected in parallel to a sixth NMOS transistor NM_22. The fourth NMOS transistor NM_20 is connected in series between the first output node N1 and the sixth NMOS transistor NM_22, and the fifth NMOS transistor NM_21 is connected in series between the second output node N2 and the sixth NMOS transistor NM_22. The fourth and fifth NMOS transistors NM_20 and NM_21 receive the inverse of the most significant bit /B0 and the most significant bit B0, respectively, at their gates. The sixth NMOS transistor NM_22 is connected between ground and the fourth and fifth NMOS transistors NM_20 and NM_21. The sixth NMOS transistor NM_22 receives a second control voltage CON_2 at its gate from the control circuit 304.

As further shown in FIG. 3, the first and second output nodes N1 and N2 are each connected to a power supply voltage VDD by a resistor R. Furthermore, the first output node N1 supplies the differential signal In_p′ and the second output node N2 supplies the differential signal In_n′.

With the arrangement of FIG. 3, if the most significant bit B1 is logic 1, then the first NMOS transistor NM_11 turns off and the second NMOS transistor NM_12 turns on. As a result, the first driver DRV_1 pulls the differential signal In_n′ towards ground while the differential signal In_p′ remains near VDD. By contrast, when the most significant bit B1 is logic 0, the first NMOS transistor NM_11 turns on and the second NMOS transistor NM_12 turns off. As a result, the first driver DRV_1 pulls the differential signal In_p′ towards ground while the differential signal In_n′ remains near VDD.

The second driver DRV_2 and the fourth, fifth and sixth transistors NM_20, NM_21 and NM_22 in the second driver DRV_2 operate in the same manner and affect the differential signals In_p′ and In_n′ based on the logic state of the least significant bit B0 and the second control voltage CON_2 in the same manner as described above with respect to the first driver DRV_1 and the first, second and third drivers NM_10, NM_11 and NM_12; albeit based on the most significant bit B1 and the first control voltage CON_1.

The first and second control voltages CON_1 and CON_2 control the amount of current flowing through the third and sixth NMOS transistors NM_12 and NM_22, respectively. Consequently, the first and second control voltages CON_1 and CON_2 affect the voltages levels of the differential signals In_p′ and In_n′ for each of the different logic state pairs for bits B1 and B0. Also, the sizes of the first-sixth transistors NM_10-NM_22 with respect to one another also control and/or affect the voltages levels of the differential signals In_p′ and In_n′.

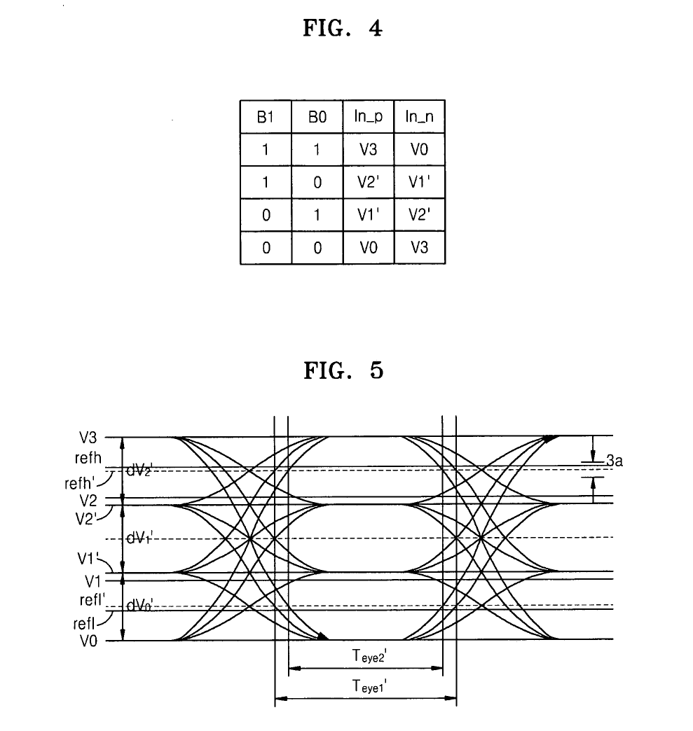

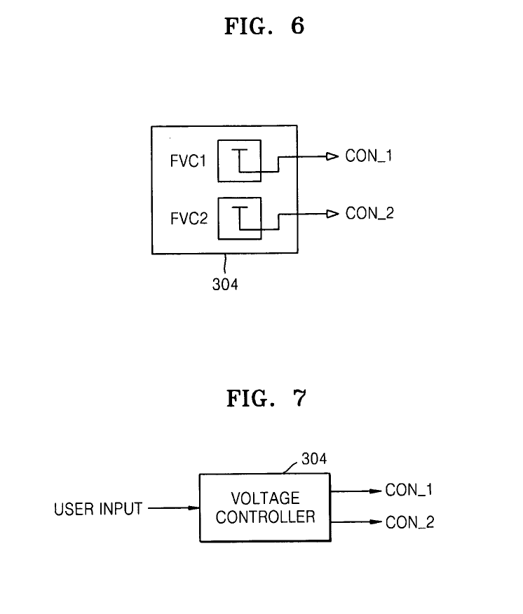

According to the present invention, the first and second control voltages CON_1 and CON_2 are set such that the differential signals In_p′ and In_n′ have the voltage levels shown in the table of FIG. 4 for the different logic state pairs of the bits B1 and B0. More specifically, the first and second control voltage CON_1 and CON_2 are set such that the first and second drivers DRV_1 and DRV_2 produce differential signals In_p′ and In_n′ having a transition diagram as shown in FIG. 5.

As shown in FIGS. 4 and 5, the differential signals may transition to voltage levels V3, V2′, V1′ or V0 where V3>V2′>V1′>V0. If input bits B0 and B1 are 11, the first and second drivers DRV_1 and DRV_2 drive the differential signal In_p′ to the voltage level V3 and the differential signal In_n′ to the voltage level V0. If input bits B0 and B1 are 10, the first and second drivers DRV_1 and DRV_2 drive the differential signal In_p′ to the voltage level V2′ and the differential signal In_n′ to the voltage level V1′. If input bits B0 and B1 are 01, the first and second drivers DRV_1 and DRV_2 drive the differential signal In_p′ to the voltage level V1′ and the differential signal In_n′ to the voltage level V2′. If input bits B0 and B1 are 00, the first and second drivers DRV_1 and DRV_2 drive the differential signal In_p′ to the voltage level V0 and the differential signal In_n′ to the voltage level V3.

As further shown in FIG. 5, the voltage interval between adjacent voltage levels V3 and V2′ is dV2′, the voltage interval between adjacent voltage levels V2′ and V1′ is dV1′, and the voltage interval between adjacent voltage levels V1′ and V0 is dV0′. The voltage intervals are such that dV2′=dV0′, but dV2′ and dV0′ are greater than dV1′. Stated another way, the center voltage interval dV1′ is less than the two adjacent voltage interval dV0′ and dV2′.

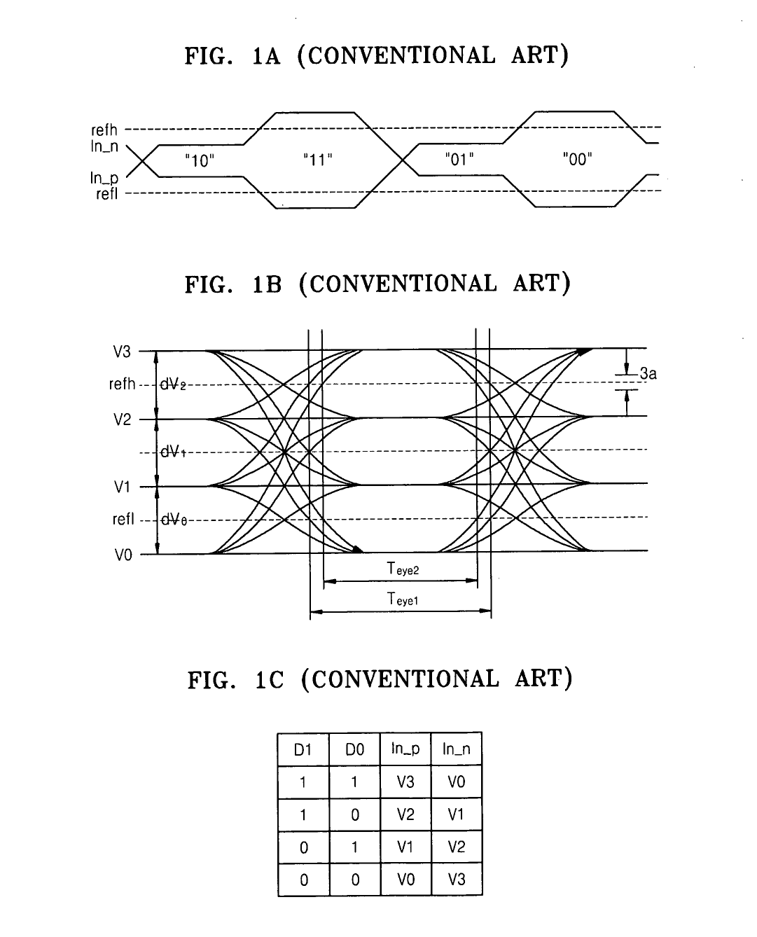

In one embodiment, the voltage level V1′ is set equal to the voltage V1 of FIGS. 1B and 1C plus 2α (i.e., V1′=V1+2α) and the voltage level V2′ is set equal to the voltage level V2 of FIGS. 1B and 1C minus 2α (i.e., V2′=V2−2α). As a result, and as discussed in greater detail below, the higher reference voltage refh′ reduces by 1α as compared to the conventional higher reference voltage refh and the lower reference voltage refl′ increases by 1α as compared to the convention lower reference voltage refl. It will be recalled from above, that the noise magnitude n of the reference voltages at the receiver are ±3α. Furthermore, the worst case voltage margin of the 4-PAM system according to this embodiment is 1dV−4α. Also, the timing margin of 4-PAM system according to this embodiment, when data transits to “11” or “00” is Teye2′ as shown in FIG. 5, which is greater than Teye2 shown in FIG. 1. Namely, by decreasing the center voltage interval dV1′ as compared to the adjacent voltage intervals dV0′ and dV1′, the voltage margin and timing margin are improved.

The inventors have recognized that (1) setting the center voltage interval dVcenter of a multi-PAM system equal to the conventional voltage interval minus B and (2) setting the remaining voltage intervals equal to one another, and therefore, greater than the center voltage interval dVcenter, optimizes the voltage and timing margins, where B is expressed as the following equation:

B=2n(N−2)/(N−1), where n=3a. (2)

where N is the number of symbols in the multi-PAM system, and n is the noise magnitude (=3α) of the reference voltage at the receiver 100 (e.g., either refh′ or refl′ as the noise magnitude of refh′=refl′=refh=refl). The center voltage interval dVcenter is the central one of the voltage intervals in the multi-PAM system. For example, for a 4-PAM system, the center voltage interval dVcenter is dV1′. Here, the dVcenter=dV1′ is set equal to dV−4α according to equation 2.

Given that the higher reference voltage refh′ according to this embodiment equals (V3+V2′)/2 and the lower reference voltage refl′ according to this embodiment equals (V1′+V0)/2, FIG. 5 shows that the higher reference voltage refh′=refh−1α and the lower reference voltage refl′=refl+1α.

As will be appreciated from the above discussion, the setting of the center voltage interval dVcenter, and therefore, the voltage levels for achieving the different symbols is based on the noise magnitude of the reference voltage at the receiver 100. Accordingly, referring back to FIG. 3, the first and second control voltages CON_1 and CON_2 are set based on the noise magnitude of the reference voltage at the receiver 100 to achieve the voltage levels and voltage interval relationships described above. Namely, the first-sixth NMOS transistors NM_10-NM22 are sized to create the voltage level and voltage interval relationships described above based on the received first and second control voltages, which effectively indicate the value of α.

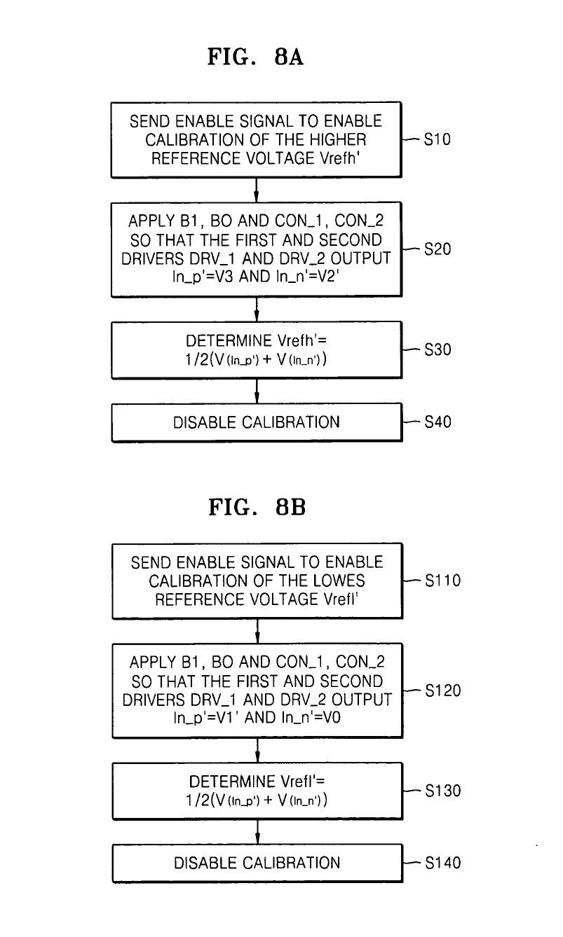

FIG. 6 illustrates a first embodiment of control circuit 304 for applying the first and second control voltages CON_1 and CON_2. In this embodiment, the control circuit 304 includes a first fixed voltage generating circuit FVC1 and a second fixed voltage generating circuit FVC2. The first and second fixed voltage generating circuits FVC1 and FVC2 each generate a fixed voltage that depends on the process conditions for forming the first and second fixed voltage generating circuits FVC1 and FVC2. These process dependencies may be established such that the process variations reflect the noise magnitude expected in the reference voltage of the receiver 100, and the fixed voltages (i.e., the first and second control voltages CON_1 and CON_2) that are generated result in the first and second drivers DRV_1 and DRV_2 generating voltage levels with voltage interval relationships as described above.

Alternatively, empirical measurements or simulations of the noise magnitude may be made, and the fixed voltage generating circuits FVC1 and FVC2 designed to produce fixed voltages commensurate with those measurements.

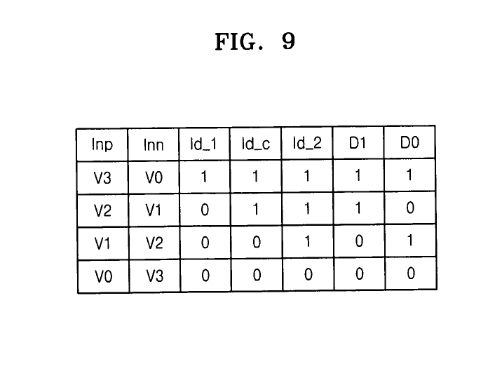

FIG. 7 illustrates another embodiment of control circuit 304 for applying the first and second control voltages CON_1 and CON_2. In this embodiment, the control circuit 304 receives user input, such as from the manufacturer of the first circuit device 300, and generates the first and second control voltages CON_1 and CON_2 based on the user input. In this embodiment, the manufacturer of the first circuit device 300 may make empirical measurements or simulations of the noise magnitude n for a reference voltage at the receiver 100 of the second circuit device 302, and then provides input to the control circuit 304 to effectively program the control circuit 304 to produce desired first and second control voltages CON_1 and CON_2. In this embodiment, the programming may be implemented by asserting appropriate pins of the first circuit device 300 that instruct or program the control circuit 304.

As will be appreciated numerous other techniques and circuits may be used to set the first and second control voltages CON_1 and CON_2 to achieve the voltage levels and voltage intervals according to the multi-PAM system of the present invention.

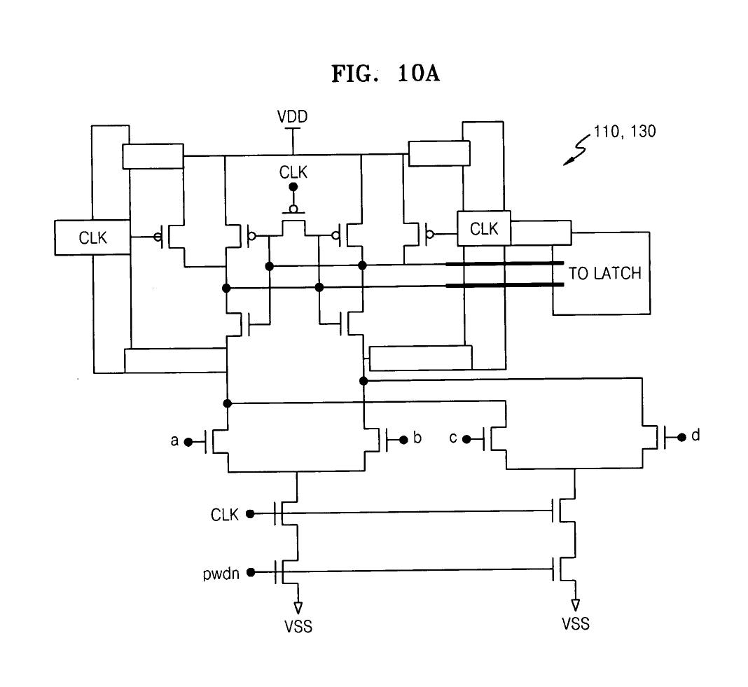

Next, operation of the calibration control signal generator 306 and the reference voltage generating circuit 350 will be described with respect to the flow charts in FIGS. 8A and 8B. The methods of FIGS. 8A and 8B may be performed after power up of the first and second circuit devices 300 and 302, and after establishing the control voltages CON_1 and CON_2. The methods of FIGS. 8A and 8B may be performed in any order.

FIG. 8A illustrates a flow chart of the method of calibrating the higher reference voltage generated by the reference voltage generating circuit 350. As shown, in step S10, the calibration control signal generator 306 sends an enable signal over the transmission medium 332 to the reference voltage generating circuit 350 to enable the reference voltage generating circuit 350 to calibrate the higher reference voltage refh′. In step S20, the calibration control signal generator 306 applies bits B1 and B0 and instructs the control circuit 304 to output control voltages CON_1 and CON_2 such that the first and second drivers DRV_1 and DRV_2 produce differential signals In_p′ and In_n′ at voltage levels V3 and V2′, respectively. In step S20, the calibration control signal generator 306 may also disable the parser 308 during calibration. As will be appreciated, step S20 may be performed before or simultaneously with step S10.

In step S30, the reference voltage generating circuit 350 receives the different signals In_p′ and In_n′, and having been enabled to generate the higher reference voltage refh′, generates the higher reference voltage refh′ according to the following expression:

refh′=(In_{—}p′+In_{—}n′)/2 (3)

After sufficient time to permit determination of the higher reference voltage refh′, the calibration control signal generator 306 sends a disable signal to the reference voltage generating circuit 350 to disable generation of the higher reference voltage refh′ in step S40. In response, the reference voltage generating circuit 350 maintains the higher reference voltage refh′ at the determined level until enabled to again calibrate the higher reference voltage refh′.

FIG. 8B illustrates a flow chart of the method of calibrating the lower reference voltage generated by the reference voltage generating circuit 350. As shown, in step S110, the calibration control signal generator 306 sends an enable signal over the transmission medium 332 to the reference voltage generating circuit 350 to enable the reference voltage generating circuit 350 to calibrate the lower reference voltage refl′. In step S120, the calibration control signal generator 306 applies bits B1 and B0 and instructs the control circuit 304 to output control voltages CON_1 and CON_2 such that the first and second drivers DRV_1 and DRV_2 produce differential signals In_p′ and In_n′ at voltage levels V1′ and V0, respectively. In step S120, the calibration control signal generator 306 may also disable the parser 308 during calibration. As will be appreciated, step S120 may be performed before or simultaneously with step S110.

In step S130, the reference voltage generating circuit 350 receives the different signals In_p′ and In_n′, and having been enabled to generate the lower reference voltage refl′, generates the lower reference voltage refl′ according to the following expression:

refl′=(In_{—}p′+In_{—}n′)/2 (4)

After sufficient time to permit determination of the lower reference voltage refl′, the calibration control signal generator 306 sends a disable signal to the reference voltage generating circuit 350 to disable generation of the lower reference voltage refl′ in step S140. In response, the reference voltage generating circuit 350 maintains the lower reference voltage refl′ at the determined level until enabled to again calibrate the lower reference voltage refl′.

Returning to FIG. 2, the receiver 100 will now be described. As shown, the receiver 100 includes a most significant bit (MSB) receive unit 110, a center receive unit 120, a least significant bit (LSB) unit 130, and a data conversion unit 150. The MSB receive unit 110 includes a comparator 112, a latch 114 and a buffer 116. The comparator 112 determines a first voltage difference Id_1 according to the following expression:

Id_{—}1=(In_{—}p′−refh′)−(In_{—}n′−refl′) (5)

Stated another way,

Id_{—}1 1=(In_{—}p′−In_{—}n′)−(refh′−refl′) (6)

The latch 114 latches the first voltage difference Id_1, and the buffer 116 buffers the first voltage difference Id_1 for input to the data conversion unit 150.

The LSB receive unit 130 includes a comparator 132, a latch 134 and a buffer 136. The comparator 132 determines a second voltage difference Id_2 according to the following expression:

Id_{—}2=(In_{—}p′−refl′)−(In_{—}n′−refh′) (7)

Stated another way,

Id_{—}2=(In_{—}p′−In_{—}n′)−(refl′−refh′) (8)

The latch 134 latches the second voltage difference Id_2, and the buffer 136 buffers the second voltage difference Id_2 for input to the data conversion unit 150.

The center receive unit 120 includes a comparator 122, a latch 124 and a buffer 126. The comparator 122 determines a center voltage difference Id_c according to the following expression:

Id_{—}c=(In_{—}p′−In_{—}n′) (9)

The latch 124 latches the center voltage difference Id_c, and the buffer 126 buffers the first voltage difference Id_c for input to the data conversion unit 150.

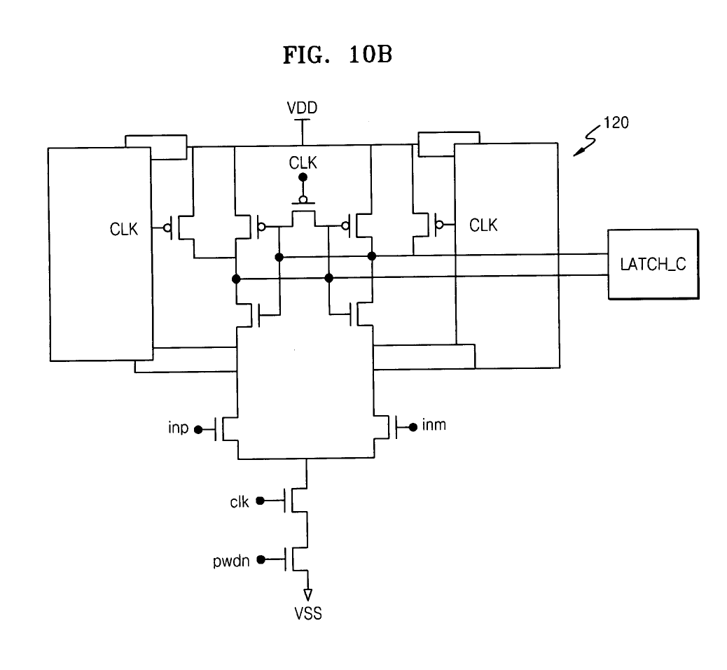

The data conversion unit 150 generates received data bits D1 and D0, corresponding to bits B1 and B0, respectively, based on the first, second and center voltage differences Id_1, Id_2 and Id_c. For example, the data conversion unit 150 may be a thermometer code to binary code converter that converts the first, second and center voltage differences Id_1, Id_2 and Id_c to data bits D1 and D0 according to the table shown in FIG. 9.

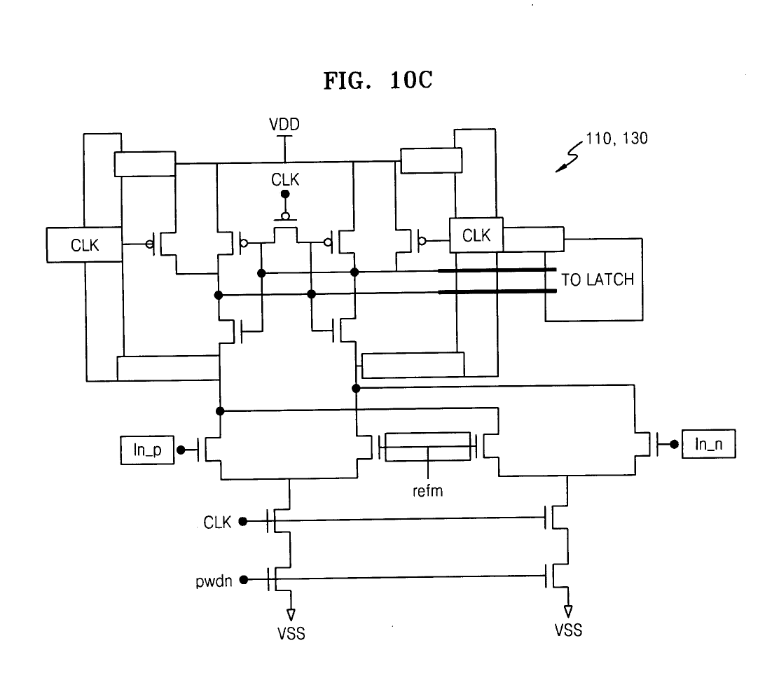

FIG. 10A illustrates a detailed circuit diagram of a comparator according to the present invention. As shown, the comparator is a well-known differential amplifier that generates an output at the logic low level of a clock signal CLK. In FIG. 10A, the comparator receives a power supply voltage VDD, a ground voltage VSS and a fixed power down voltage pwdn, which controls current flow to ground VSS. The comparator of FIG. 10A may be used as the comparator 112 and/or the comparator 132. If the comparator of FIG. 10A serves as the comparator 112, then the inputs a, b, c and d in FIG. 10A are In_p′, refh′, refl′ and In_n′, respectively. If the comparator of FIG. 10A serves as the comparator 132, then the inputs a, b, c and d in FIG. 10A are In_n′, refl′, refh′ and In_p′. It will be appreciated, however, that comparators 112 and 132 are not limited to this implementation. Instead, numerous circuits for effecting the determination of the first and second difference voltages Id_1 and Id_2 according to the expressions above will be within the level of one skilled in the art.

FIG. 10B illustrates detailed circuit diagrams of a center comparator 122 according to the present invention. As shown, the comparator is a simple, well-known differential amplifier that generates an output at the logic low level of a clock signal CLK. In FIG. 10B, the comparator receives a power supply voltage VDD, a ground voltage VSS and a fixed power down voltage pwdn, which controls current flow to ground VSS.

FIG. 10C illustrates detailed circuit diagrams of another center comparator 122 according to the present invention. As shown, the comparator is a more complicated, well-known differential amplifier that generates an output at the logic low level of a clock signal CLK based on a reference voltage refm. In FIG. 10B, the comparator receives a power supply voltage VDD, a ground voltage VSS and a fixed power down voltage pwdn, which controls current flow to ground VSS. The reference voltage refm is less than the higher reference voltage refh′, but greater than the lower reference voltage refl′. The reference voltage refm is a design parameter that may be set to match the delay between the comparators 112, 132 and the comparator 122.

It will be appreciated, however, that the comparator 122 is not limited to this implementation. Instead, numerous circuits for effecting the determination of the center voltage difference Id_c according to the expression above will be within the level of one skilled in the art.

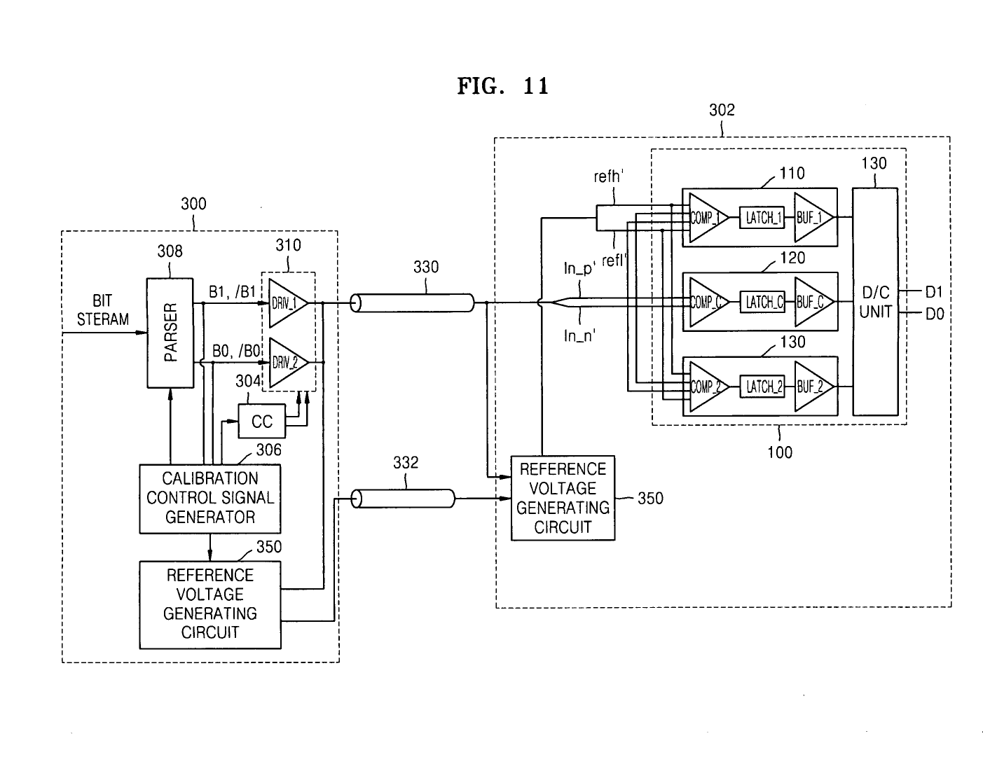

FIG. 11 illustrates a transceiver system according to another embodiment of the present invention. In particular, FIG. 11 illustrates another transceiver system employing the 4-PAM signaling according to the present invention. This embodiment is the same as the embodiment of FIG. 2, except that the reference voltage generating circuit 350 has been moved to the first circuit device 300, and the higher and lower reference voltages refh′ and refl′ are sent over the second transmission medium 322 to the second circuit device 302 instead of the calibration enable signals. Because the structure and operation of this embodiment is otherwise the same as that of FIG. 2, a description thereof will not be repeated for the sake of brevity.

While the embodiments described thus far have pertained to a 4-PAM signaling system, it should be readily apparent that the present invention is not limited to 4-PAM signaling. Instead, the present invention is applicable to any multi-PAM signaling.

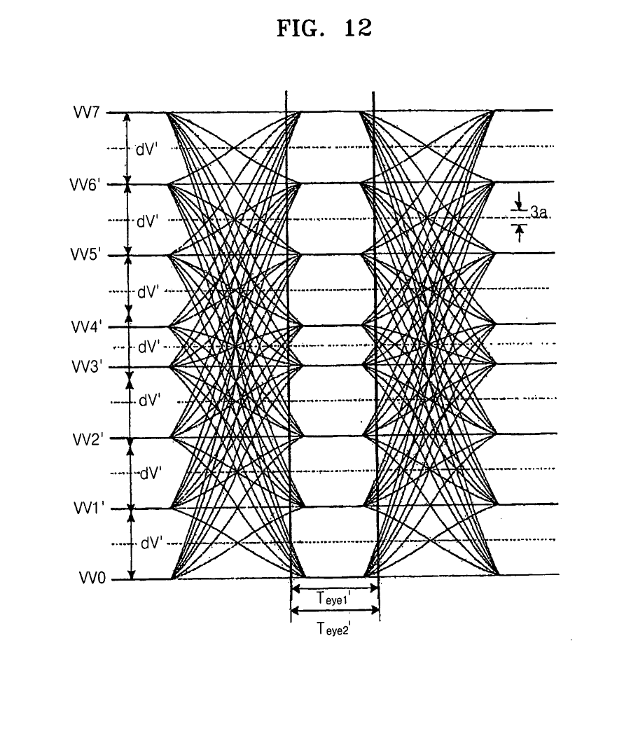

As another example, FIG. 12 illustrates the transition diagram for 8-PAM signaling according to an embodiment of the present invention. In 8-PAM signaling, eight different symbols exist, each representing a different set of three bits. As shown, and as is characteristic of the present invention, the central voltage interval dVc is less than the other voltage intervals dV′, which are equal. Referring back to equation 2, the central voltage interval dVc is set equal to dVs−5.14α, where dVs is the voltage interval if all of the voltage intervals were set equal to one another. As such, the 8-PAM signaling includes eight voltage levels VV0, VV1′, VV2′, VV3′, VV4′, VV5′, VV6′, VV7.

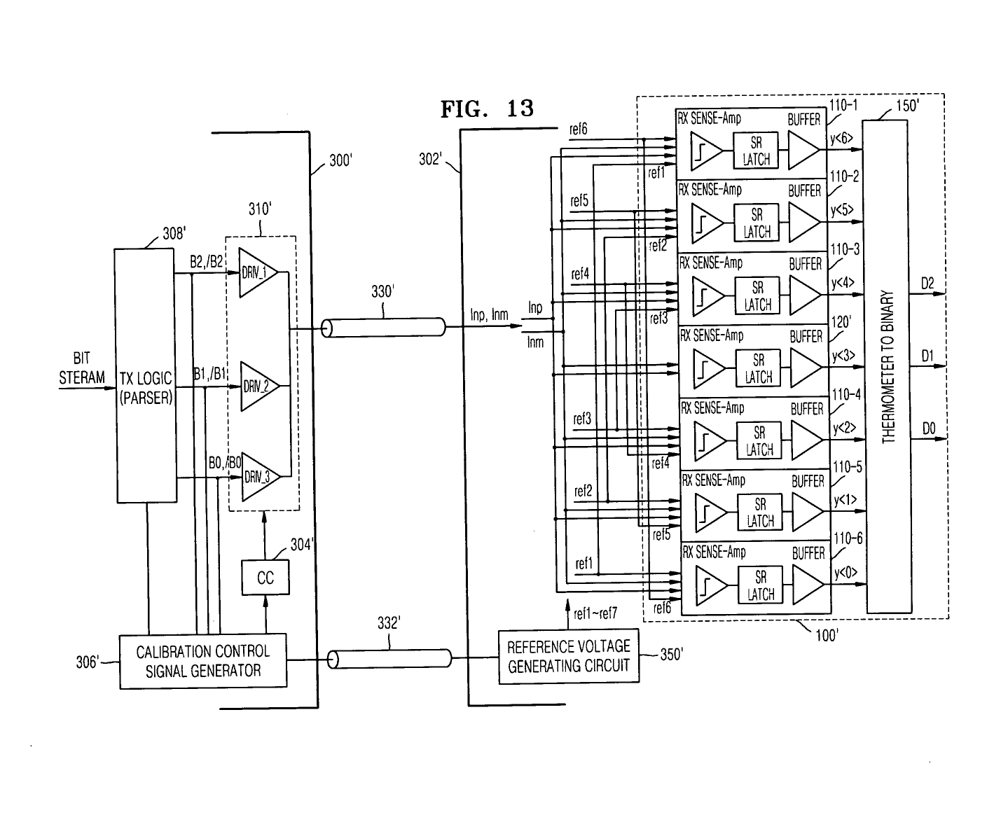

FIG. 13 illustrates a transceiver system according to an embodiment of the present invention for implementing the 8-PAM signaling of FIG. 12. As shown, the basic structure of the transceiver system in FIG. 13 is the same as the transceiver system in FIG. 2. Namely, the transceiver system includes a first circuit device 300′ communicatively coupled to a second circuit device 302′ via a first transmission medium 330′ and a second transmission medium 332′. While shown as wired transmission media in FIG. 13, the first and second transmission media 330′ and 332′ may instead be wireless transmission media. A wired transmission medium may be any wired transmission medium capable of transferring signals representing data such as optical fiber, copper wires or other conductive material, etc. Furthermore, instead of being separate media, the first and second transmission media 330′ and 332′ may be separate channels on a same transmission media—either wired or wireless.

The first circuit device 300′ has the same basic structure as the first circuit device 300 shown in FIG. 2. Namely, the first circuit device 300′ includes a control circuit 304′, a calibration control signal generator 306′, a parser 308′ and a transmitter 310′. Similarly, the second circuit device 302′ has the same basic structure as the second circuit device 302 in FIG. 2, and includes a receiver 100′ and a reference voltage generating circuit 350′. It will be understood that the first circuit device 300′ and the second circuit device 302′ may include other elements and components performing various functions, etc.; however, these other aspects will not be described in detail for the sake of brevity.

As shown, the calibration control signal generator 306′ generates calibration control signals, which are sent to the second circuit device 302′ to control calibration of the reference voltages generated by the reference voltage generator 350′ in the second circuit device 302′. This will be described in more detail below with respect to the second circuit device 302′. As further shown in FIG. 13, the parser 308′ receives a bit stream and parses the bit stream into groups or symbols of three bits B2B1B0. The most significant bit B2 and the inverse /B2 are supplied to a first driver DRV_1 in the transmitter 310′. The next most significant bit B1 and the inverse /B1 are supplied to a second driver DRV_2, and the least significant bit B0 and the inverse /B0 are supplied to a third driver DRV_3 of the transmitter 310′. Accordingly, as will be appreciated, the parser 308′ parses the bit stream into symbols. The first-third drivers DRV_1, DRV_2 and DRV_3 generate a differential signal pair In_p′ and In_n′ based on the bits B2, /B2, B1, /B1, B0, and /B0. In particular, the first-third drivers DRV_1, DRV_2 and DRV_3 generate the differential signal pair In_p′ and In_n′ based on these bits and control voltages received from the control circuit 304′.

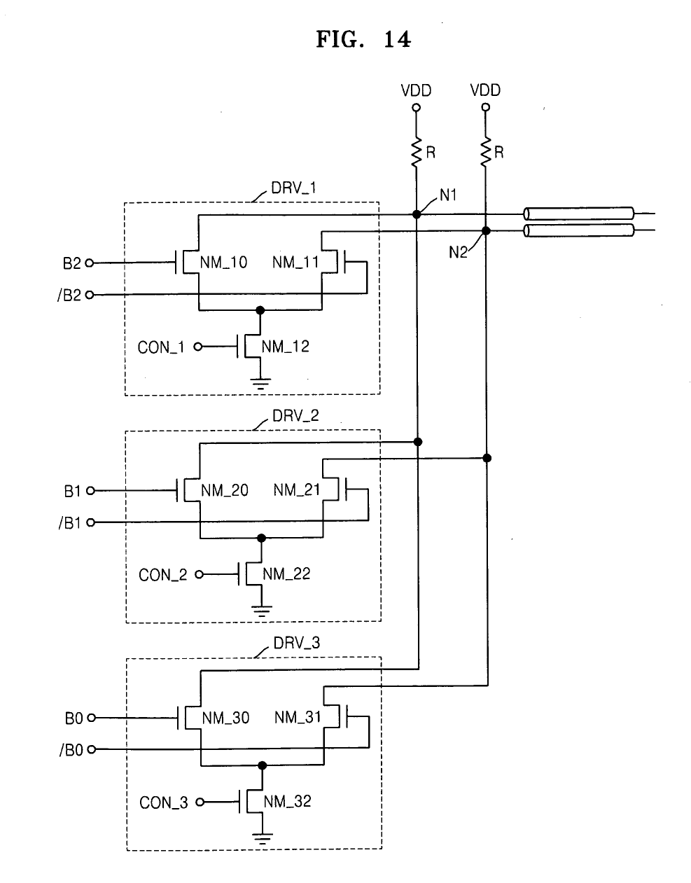

FIG. 14 illustrates an embodiment of the first-third drivers DRV_1, DRV_2 and DRV_3 according to one embodiment of the present invention. As shown, the first driver DRV_1 and the second driver DRV_2 have the same structure as described above with respect to FIG. 3, except that the first driver DRV_1 receives the bits B2 and /B2 and the second driver DRV_2 receives the bits B1 and /B1. The third driver DRV_3 includes NMOS transistors NM_30 and NM_31 connected in parallel to a third NMOS transistor NM_32. The first NMOS transistor NM_30 is connected in series between a first output node N1 and the third NMOS transistor NM_32, and the second NMOS transistor NM_31 is connected in series between a second output node N2 and the third NMOS transistor NM_32. The first and second NMOS transistors NM_30 and NM_31 receive the inverse of the least significant bit /B0 and the least significant bit B0, respectively, at their gates. The third NMOS transistor NM_32 is connected between ground and the first and second NMOS transistors NM_30 and NM_31. The NMOS transistors NM_12, NM22 and NM32 receive first-third control voltages CON_1, CON_2 and CON_3 at their gates from the control circuit 304′.

As further shown in FIG. 3, the first and second output nodes N1 and N2 are each connected to a power supply voltage VDD by a resistor R. Furthermore, the first output node N1 supplies the differential signal In_p′ and the second output node N2 supplies the differential signal In_n′.

Because the arrangement of FIG. 13 is substantially similar to that of FIG. 3, the operation of the drivers in FIG. 13 will be readily apparent from the description of FIG. 3. Furthermore, from the description of FIG. 3, it will be appreciated that the first-third control voltages CON_1, CON_2 and CON_3 are set such that the differential signals In_p′ and In_n′ have the voltage levels shown in the table below for the different logic states of the bits B2, B1 and B0.

TABLE

| B2 | B1 | B0 | In_p′ | In_n |
|---|---|---|---|---|
| 1 | 1 | 1 | VV7 | VV0 |
| 1 | 1 | 0 | VV6′ | VV1′ |
| 1 | 0 | 1 | VV5′ | VV2′ |
| 1 | 0 | 0 | VV4′ | VV3′ |
| 0 | 1 | 1 | VV3′ | VV4′ |
| 0 | 1 | 0 | VV2′ | VV5′ |
| 0 | 0 | 1 | VV1′ | VV6′ |
| 0 | 0 | 0 | VV0 | VV7 |

More specifically, the first-third control voltage CON_1, CON_2 and CON_3 are set such that the first-third drivers DRV_1, DRV_2 and DRV_3 produce differential signals In_p′ and In_n′ having a transition diagram as shown in FIG. 12.

As shown in the above table and FIG. 12, the differential signals may transition to voltage levels VV7, VV6′, VV5′, VV4′, VV3, VV2′, VV1′ or VV0 where VV7>VV6′>VV5′>VV4′>VV3′>VV2′>VV1′>VV0. As further shown in FIG. 12, the voltage intervals are such the center voltage interval dVc′ is less than the other voltage intervals, and the other voltage intervals are equal (=dV′). Accordingly, this embodiment achieves the same advantages as discussed above with respect to the embodiment of FIG. 2.

The control circuit 304′ may generate the control voltages CON_1, CON_2 and CON_3 in the same manner as described above with respect to the control circuit 304, albeit, three control voltages are generated.

Similarly, the operation of the calibration control signal generator 306′ and the reference voltage generating circuit 350′ may be the same as the calibration control signal generator 306, except that instead of generating two reference voltages, the generator 306′ generates six reference voltages ref1-ref6. As will be appreciated from the description of FIG. 2, reference voltage ref1-ref6 are generated such that:

ref1=(VV1′+VV0)/2

ref2=(VV2′+VV1′)/2

ref3=(VV3′+VV2′)/2

ref4=(VV5′+VV4′)/2

ref5=(VV6′+VV5′)/2

ref6=(VV7′+VV6′)/2

Returning to FIG. 13, the receiver 100′ will now be described. As shown, the receiver 100′ includes six upper/lower receive units 110-i, for i=1 to 6; a center receive unit 120′; and a data conversion unit 150′. The six upper/lower receiver units 110-i have the same structure as the receive units 110 and 130 described with respect to FIG. 2. However, the comparators 112-i in the first-sixth upper/lower receive units 110-i respectively generate voltage differences Id_1 through Id_6 according to the following expressions:

Id_{—}1=(In_{—}p′−In_{—}n′)−(ref6−ref1)

Id_{—}2=(In_{—}p′−In_{—}n′)−(ref5−ref2)

Id_{—}3=(In_{—}p′−In_{—}n′)−(ref4−ref3)

Id_{—}4=(In_{—}p′−In_{—}n′)−(ref3−ref4′)

Id_{—}5=(In_{—}p′−In_{—}n′)−(ref2−ref5′)

Id_{—}6=(In_{—}p′−In_{—}n′)−(ref1−ref6′)

The latches 114 respectively latch the voltage differences Id_1 through Id_6, and the buffers 116 respectively buffer the first voltage differences Id_1 though Id-6 for input to the data conversion unit 150.

The center receive unit 120′ has the same structure as the center receive unit 120 in FIG. 2. The comparator 122 determines a center voltage difference Id_c according to the following expression:

Id_{—}c=(In_{—}p′−In_{—}n′) (9)

The latch 124 latches the center voltage difference Id_c, and the buffer 126 buffers the first voltage difference Id_c for input to the data conversion unit 150. The data conversion unit 150′ generates received data bits D2, D1 and D0, corresponding to bits B2, B1 and B0, respectively, based on the first-sixth voltage differences Id_1 through Id_6 and the center voltage difference Id_c. For example, the data conversion unit 150′ may be a thermometer code to tertiary code converter that converts the voltage differences Id_1, Id_2 and Id_c to data bits.

As will be appreciated from FIGS. 2 and 13, the present invention may scale to any level of multi-PAM signal.

While in the embodiments described above, the first circuit device 300 was described as including the transmitter 310 and associated elements, it should be understood, that the second circuit device 302 may also include a transmitter and associated elements having the same structure and operation as in the first circuit device 300. Also, while in the embodiments described above, the second circuit device 302 was described as including the receiver 100, the first circuit device 302 may also include a receiver having the same structure and operation as the receiver 100. Furthermore, it should be understood that the first and second circuit devices may transmit and/or receive data from more than one circuit device.

The invention being thus described, it will be obvious that the same may be varied in many ways. Such variations are not to be regarded as a departure from the invention, and all such modifications are intended to be included within the scope of the invention.

We claim:

1. An apparatus for multi-level communication, comprising:
a driver circuit configured such that for each symbol in a set of possible symbols, the driver circuit generates at least one data signal at an associated voltage level, adjacent voltage levels defining an associated voltage interval; and
the driver circuit configured to generate the voltage levels such that a central voltage interval is less than at least one of the voltage intervals adjacent to the central voltage interval.

2. The apparatus of claim 1, wherein the central voltage interval is less than both the voltage intervals adjacent to the central voltage interval.

3. The apparatus of claim 1, wherein the voltages intervals other than the central voltage interval are equal.

4. The apparatus of claim 3, wherein a difference between the central voltage interval and the other voltage intervals is based on a noise magnitude of at least one reference voltage in a receiver circuit, which determines the symbols represented by the data signal.

5. The apparatus of claim 4, wherein the difference is further based on a number of symbols in the set of possible symbols.

6. The apparatus of claim 1, wherein a difference between the central voltage interval and the other voltage intervals is based on a noise magnitude of at least one reference voltage in a receiver circuit, which determines the symbols represented by the data signal.

7. The apparatus of claim 6, wherein the difference is further based on a number of symbols in the set of possible symbols.

8. The apparatus of claim 1, wherein the voltage levels are established by sizes of transistors in the driver circuit.

9. The apparatus of claim 1, wherein the voltage levels are established by control voltages applied to the driver circuit.

10. The apparatus of claim 1, further comprising:
a control circuit configured to apply the bias control voltages based on user input.

11. The apparatus of claim 1, wherein a number of symbols in the set of possible symbols is four, and each symbol represents two bits.

12. The apparatus of claim 1, wherein a number of symbols in the set of possible symbols is eight, and each symbol represents three bits.

13. The apparatus of claim 1, further comprising:
a calibration circuit configured to enable calibration of reference voltages generated at a receiver, and configured to control operation of the driver circuit to generate the data signal for use in calibrating the generation of the reference voltages if calibration is enabled.

14. The apparatus of claim 1, further comprising:
a calibration circuit configured to enable calibration of reference voltages, and configured to control operation of the driver circuit to generate the data signal for use in the calibrating the reference voltages if calibration is enabled; and
a reference voltage generator configured to calibrate reference voltages based on the data signal if enabled by the calibration circuit.

15. The apparatus of claim 14, wherein the reference voltage generating unit is configured to send the calibrated reference voltages to a receiver.

16. An apparatus for multi-level communication, comprising:
a reference voltage generating circuit configured to generate reference voltages for determining symbols represented by at least one data signal, the data signal being at different voltage levels for each symbol in a set of possible symbols, adjacent voltage levels defining an associated voltage interval, a central voltage interval being less than at least one of the voltage intervals adjacent to the central voltage interval, and the reference voltage generating circuit configured to generate a reference voltage associated with each voltage interval except the central voltage interval, and each reference voltage being at a median of the associated voltage interval; and
a determination circuit configured to determine the symbol represented by the data signal based on the generated reference voltages.

17. The apparatus of claim 16, wherein the determination circuit includes at least one comparison circuit configured to compare the data signal to at least one of the reference voltages, and the determination circuit is configured to determine the symbol represented by the data signal based on output from the comparison circuit.

18. The apparatus of claim 16, wherein the reference voltage generating circuit is configured to calibrate generation of the reference voltages based on the data signal if a calibration enable signal is received.

19. An apparatus for multi-level communication, comprising:
a determination circuit configured to determine a symbol represented by at least one data signal based on reference voltages, the data signal being at different voltage levels for each symbol in a set of possible symbols, adjacent voltage levels defining an associated voltage interval, a central voltage interval being less than at least one of the voltage intervals adjacent to the central voltage interval; and
the reference voltage generating circuit configured to generate the reference voltages, each reference voltage being associated with one of the voltage intervals except the central voltage interval, and each reference voltage being at a median of the associated voltage interval.

20. The apparatus of claim 19, wherein the determination circuit includes at least one comparison circuit configured to compare the data signal to at least one of the reference voltages, and the determination circuit is configured to determine the symbol represented by the data signal based on output from the comparison circuit.

21. The apparatus of claim 19, wherein the reference voltage generating circuit is configured to calibrate generation of the reference voltages based on the data signal if a calibration enable signal is received.

22. An method for multi-level communication, comprising:
receiving a symbol from a set of possible symbols for transmission;
generating a data signal at a voltage level from a set of possible voltage levels based on the received symbol, each voltage level in the set of possible voltage levels for the data signal being associated one of the symbols in the set of possible symbols, the set of voltage levels being such that adjacent voltage levels defme an associated voltage interval and a central voltage interval is less than at least one of the voltage intervals adjacent to the central voltage interval.

23. The method of claim 22, wherein the central voltage interval is less than both the voltage intervals adjacent to the central voltage interval.

24. The method of claim 22, wherein the voltages intervals other than the central voltage interval are equal.

25. The method of claim 24, wherein a difference between the central voltage interval and the other voltage intervals is based on a noise magnitude of at least one reference voltage in a receiver circuit, which determines the symbols represented by the data signal.

26. The method of claim 25, wherein the difference is further based on a number of symbols in the set of possible symbols.

27. The method of claim 22, wherein a difference between the central voltage interval and the other voltage intervals is based on a noise magnitude of at least one reference voltage in a receiver circuit, which determines the symbols represented by the data signal.

28. The method of claim 27, wherein the difference is further based on a number of symbols in the set of possible symbols.

29. The method of claim 22, wherein a number of symbols in the set of possible symbols is four, and each symbol represents two bits.

30. The method of claim 22, wherein a number of symbols in the set of possible symbols is eight, and each symbol represents three bits.

31. The method of claim 22, further comprising:
enabling calibration of reference voltages; and
controlling the generation of the data signal to generate a data signal for use in calibrating the generation of the reference voltages while the calibration is enabled.

32. The method of claim 31, further comprising:
calibrating reference voltages based on the generated data signal if calibration is enabled.

33. A method for multi-level communication, comprising:
generating reference voltages for determining symbols represented by at least one data signal, the data signal being at different voltage levels for each symbol in a set of possible symbols, adjacent voltage levels defining an associated voltage interval, a central voltage interval being less than at least one of the voltage intervals adjacent to the central voltage interval, the generating step generating a reference voltage associated with each voltage interval except the central voltage interval, and each reference voltage being at a median of the associated voltage interval; and
determining the symbol represented by the data signal based on the generated reference voltages.

34. The method of claim 33, wherein the determining step includes comparing the data signal to at least one of the reference voltages, and determining the symbol represented by the data signal based on the comparison.

35. The method of claim 33, further comprising:
calibrating the generation of the reference voltages based on the data signal if a calibration enable signal is received.

36. A method for multi-level communication, comprising:
determining a symbol represented by at least one data signal based on reference voltages, the data signal being at different voltage levels for each symbol in a set of possible symbols, adjacent voltage levels defining an associated voltage interval, a central voltage interval being less than at least one of the voltage intervals adjacent to the central voltage interval; and
generating the reference voltages, each reference voltage being associated with one of the voltage intervals except the central voltage interval, and each reference voltage being at a median of the associated voltage interval.

37. The method of claim 36, wherein the determining step includes comparing the data signal to at least one of the reference voltages, and determining the symbol represented by the data signal based on the comparison.

38. The method of claim 36, further comprising:
calibrating the generation of the reference voltages based on the data signal if a calibration enable signal is received.
